(19) United States
(12) Patent Application Publication
(10) Pub. No.: US 2014/0157138 A1
(43) Pub. Date: Jun. 5, 2014

(54) PEOPLE AS APPLICATIONS

(71) Applicant: Google Inc., Mountain View, CA (US)

(72) Inventors: Alexander Friedrich KUSCHER, San Francisco, CA (US); John Nicholas Jitkoff, Palo Alto, CA (US); Caesar Sengupta, Sunnyvale, CA (US)

(73) Assignee: Google Inc., Mountain View, CA (US)

(21) Appl. No.: 13/690,980

(22) Filed: Nov. 30, 2012

(51) Int. Cl. G06F 3/0481

(52) U.S. Cl. CPC G06F 3/04817
USPC 715/739

(57) ABSTRACT

The subject disclosure relates to associating contacts with corresponding system actions. It includes identifying a contact profile for configuring with system actions, based on one or more of an address book, user input, online accounts, or an interaction with a contact corresponding to the contact profile, retrieving contact information for the identified contact profile and determining at least one available system action based on the retrieved contact information for the identified contact profile. The disclosure also includes generating, based on the retrieved contact information, a system icon representing the contact profile for displaying the contact profile in a graphic user interface component of an operating system and associating the at least one available system action with the contact profile by configuring the at least one available system action to automatically launch when selected at the system icon representing the contact profile.

### BACKGROUND

The subject disclosure relates generally to application management, and more particularly to associating contacts with corresponding system action.

Currently, most functionality in an operating system is built from an application-centric approach. That is, to send an email to a contact, a user launches an email application; to send an instant message to a contact, the user launches yet another application, and so on. Once the appropriate application is launched, the user selects one or more contacts with whom he or she wishes to communicate or otherwise interact (e.g., to share a document). Furthermore, when users receive communications, users have to check each respective application corresponding to the type of the incoming communication. Even when notifications are provided, users may not readily know which contact sent the communication. It is therefore difficult to identify important communications from the notifications alone, and users may miss out on important communications from certain contacts if the users do not open and check the right application.

### SUMMARY

The subject disclosure relates to a machine-implemented method for associating contacts with corresponding system actions. The method includes identifying a contact profile for configuring with system actions, based on one or more of an address book, user input, online accounts, or an interaction with a contact corresponding to the contact profile, retrieving contact information for the identified contact profile and determining at least one available system action based on the retrieved contact information for the identified contact profile, wherein each available system action corresponds to at least one part of the retrieved contact information for the identified contact profile. The method also includes generating, based on the retrieved contact information, a system icon representing the contact profile for displaying the contact profile in a graphic user interface component of an operating system and associating the at least one available system action with the contact profile by configuring the at least one available system action to automatically launch when selected at the system icon representing the contact profile.

The subject disclosure also relates to a machine-readable medium with instructions stored therein, which when executed by the processors, cause the processors to perform operations that include identifying an incoming action, determining whether the identified incoming action is from a priority contact profile, wherein the priority contact profile is identified based on at least one of interaction history, user preferences, user input or physical proximity and in a case where the identified incoming action is for the priority contact profile, transmitting a notification about the identified incoming action to a system icon representing the priority contact profile, wherein the identified incoming action is accessible from the system icon representing the priority contact profile.

The subject disclosure also relates to a method for sharing content. The method includes receiving, at a system icon representing a contact, a content item for sharing with the contact, determining, based at least on one of a type of the received content item or a contact profile associated with the contact, a sharing scheme for sharing the received content item with the contact and sharing the received content item with the contact according to the determined sharing scheme, in response to receiving the content item at the system icon representing the contact.

It is understood that other configurations of the subject technology will become readily apparent from the following detailed description, where various configurations of the subject technology are shown and described by way of illustration. As will be realized, the subject technology is capable of other and different configurations and its several details are capable of modification in various other respects, all without departing from the scope of the subject technology. Accordingly, the drawings and detailed description are to be regarded as illustrative in nature and not as restrictive.

### BRIEF DESCRIPTION OF THE DRAWINGS

Certain features of the subject technology are set forth in the appended claims. However, for purpose of explanation, several implementations of the subject technology are set forth in the following figures.

FIG. 1 is a diagram of an example system for associating contacts with corresponding system actions.

FIG. 2 illustrates a flow diagram of an example process for associating contacts with corresponding system actions.

FIG. 3 illustrates a flow diagram of an example process for transmitting notifications of incoming actions to system icons associated with priority contacts.

FIG. 4 illustrates a flow diagram of an example process for sharing content.

FIG. 5 illustrates an example graphical implementation of a system for sharing content according to an aspect of the disclosed technology.

FIG. 6 conceptually illustrates an example of system for associating contacts with corresponding system actions.

FIG. 7 conceptually illustrates an example electronic system with which some aspects of the subject technology are implemented.

### DETAILED DESCRIPTION

In the following detailed description, numerous specific details are set forth to provide a full understanding of the present disclosure. It will be apparent, however, to one ordinarily skilled in the art that the embodiments of the present disclosure may be practiced without some of these specific details. In other instances, well-known structures and techniques have not been shown in detail so as not to obscure the disclosure.

According to various aspects of the subject technology, methods and systems for associating contacts with corresponding system actions are provided. According to the disclosed methods and systems, contacts' profiles are configured to act as applications from which different actions can be taken on the underlying contacts. Each contact or a group of contacts may be its own application within an operating system. The available actions correspond to the kinds of contact information that are available for a particular contact. For example, an application icon that represent a contact named “June” may offer an option to “Compose Email” or “Send SMS,” provided the corresponding contact information (e.g., email address and phone number, respectively) is available for the contact “June.” The application icon may be a photo of “June” or another avatar pulled from an address book or an online profile.

An application may be configured to cause an action to be carried out within the application. That is, a short IM message to the contact “June” may be composed directly, or in-line, in the “June” application. Alternatively, to compose an email message, the “June” application may cause an email application to be launched. Outbound actions that may be carried out in an application associated with a contact include, but are not limited to, email, chat, voice calling, text, video, drag and drop for sharing files and social network streams. For example, a user may select a file from his or her documents and drag the file to an icon representing a user's contact. The user may drop the file onto the icon, which may cause the file to automatically be shared to the contact represented by the icon. The icon may represent a single contact or a group of contacts. The group of contacts may be based on an email list, a social network affiliation, or another similar basis for identifying related contacts. Lists of contacts may appear as special applications in an operating system applications menu.

Some contacts' profiles may be visually linked (e.g., pinned) to the task bar in an operating system. The contact profiles displayed in the task bar may be priority contacts, or those who are frequently in communication with the user, are marked (e.g., starred) or otherwise favored by the user. Priority contacts may also be those who are in close physical proximity to the user. The contacts who are detected to be in a close physical proximity to the user may be dynamically surfaced in the task bar when their location is within a predetermined range to the user. They may be removed from the task bar when they are too far away.

When incoming communications are received by the user from the contact “June,” the “June” application may display a badge indicative of the new received message, regardless of the kind of underlying application that received the message. In other words, a notification with a “1” may appear next to or above the “June” application icon when a new email or instant message comes in from the contact “June.” The user is thus notified of the new message in the “June” application, without having to check the email or the instant message application. The user may then view or access the new message directly from the “June” application, or the “June” application may cause another application to be launched in order for the user to view the message. Incoming actions that are surfaced in a contact's application include, but are not limited to, email, chat, voice calling, text, video, drag and drop for sharing files and social network streams. According to an aspect of the disclosed technology, notifications about incoming communications are displayed for contacts who are pinned to the task bar. To view communications from the contacts who are not surfaced in the task bar, the user may still have to follow the usual channels of checking for updates from those contacts (e.g., checking other applications).

According to the methods and systems disclosed herein, an operating system or an application therein or in communication therewith may select one or more contacts whose profiles are to be configured as applications. Such contacts may be identified based on a frequency of interactions with the user, user designation (e.g., a contact designated as a favorite or important), or proximity (e.g., those who are detected by the system to be nearby). The identified contacts may also be manually pinned to the applications launcher menu or task bar by the user. Contacts may also be pulled from an online platform such as a social network with which the user interacts. A group of contacts may be created based on the user's affiliations at the social network. Contacts who are periodically detected in the proximity of the user may be surfaced dynamically, according to whether or not they are in proximity at any given time. The identified contacts may be surfaced in the applications launcher menu or a task bar. Contacts are surfaced along with an icon that uniquely identifies each contact. The icon may be, for example, an avatar pulled from an online profile.

For each contact, corresponding contact information is retrieved. The contact information may be retrieved from the user's address book, the contact's online profiles, history of communications, or other similar sources of contact information. The contact information may also include communication preferences, frequency of communications or online profile information, including a picture.

Available system actions are determined from the retrieved contact information for the identified contact profile. Each available system action corresponds to at least one piece of data in the contact information for the identified contact profile. That is, for each contact profile, the system determines, based on the contact information, the various ways in which the contact may be contacted. If an email address is included in the contact information, the contact may receive email. If a phone number is included in the contact information, the contact may receive voice calls and SMS. The contact information thus determines the available system actions for a particular contact.

A system icon representing the contact profile is selected for displaying the contact profile in a graphic user interface component of an operating system. The system icon is selected from the identified contact information. A system icon cover may be an online profile picture or another avatar for the contact.

The available system actions are then associated with the contact profile by configuring the available system actions in the operating system to automatically launch when an available system actions is selected at the system icon representing the contact profile. In other words, the system icon representing the contact profile acts as an umbrella for one or more applications that can be triggered or launched at the operating system from the system icon. The system icon representing the contact profile may likewise receive notifications about incoming actions that correspond to one or more actions that are available for a particular contact. For example, when an email message is received from a contact, the contact's icon may show a notification regarding the received email message.

According to an aspect, the system icon may be dragged into an email message or an instant message and the address field may be populated with the corresponding information found in the contact profile represented by the system icon.

According to another aspect, Hovering over a system icon allows a user to choose the mode of communication for communicating with the contact represented by the system icon.

According to yet another aspect, a contact may be created that is a combination of two or more contacts. That is, a group of contacts may be represented by a system icon. The group may be created by merging the corresponding system icons into one, by dragging and dropping the icons on top of each other.

A system icon may also include a summary or preview of the most recent communication.

A system icon may also display a contact's connections at a social network. For example, the other connections may be deemed interesting to a user and displayed in the system icon representing the contact, for the user to be able to share content with the contact's connections.

A user's contacts may appear in the operating system' search box, similarly to other applications. Thus, an application for a particular contact may be pinned to the task bar or searchable through menus, similar to other applications.

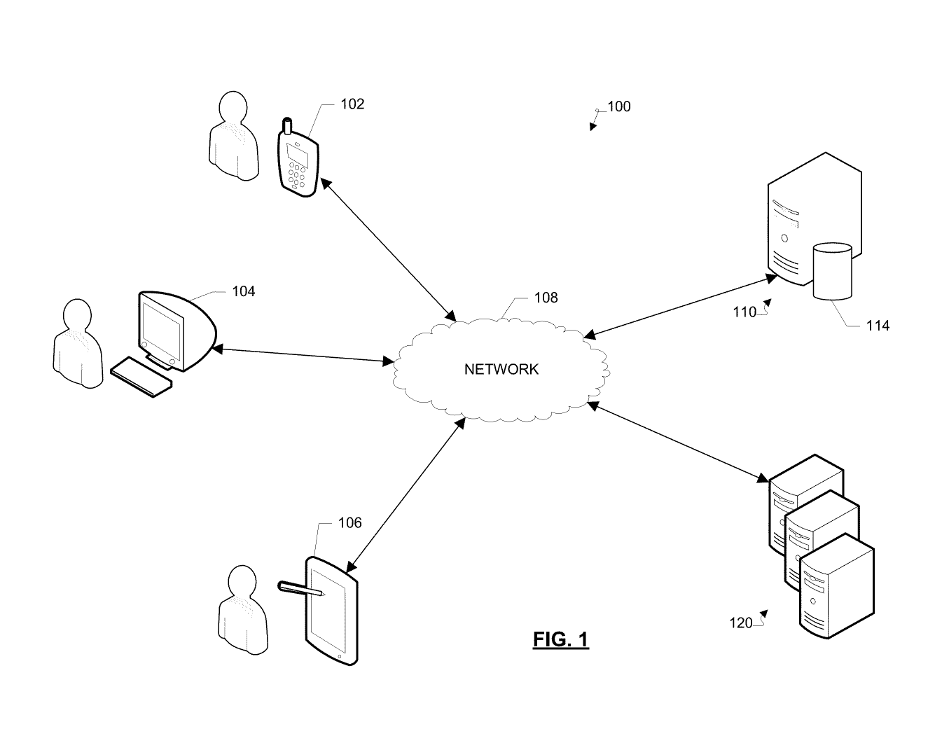

FIG. 1 illustrates an example client-server network environment which provides for associating contacts with corresponding system actions. A network environment 100 includes a number of electronic devices 102, 104 and 106 communicably connected to a server 110 by a network 108. Server 110 includes a processing device 112 and a data store 114. Processing device 112 executes computer instructions stored in data store 114, for example, instructions to identify a contact profile, retrieve contact information for the identified contact profile, determine available system actions for the contact profile based on the retrieved contact information, generate a system icon for the contact profile or associate available system actions with the contact profile. Data store 114 may store information pertaining to contact profiles, such as an email address, a phone number, a social network alias, etc. and may be accessible by the various applications within which some of the processes discussed herein are implemented, including, but not limited to, a social networking service, an email service or a blogging service. Processing device 112 may process the contact information to determine available system actions for a contact profile, for example.

Servers 110 or application servers 120 may host an application within which some of the processes discussed herein are implemented, including but not limited to, social networking service, email service or blogging service. In some example aspects, electronic devices or client devices, as used interchangeably herein, 102, 104 and 106 can be computing devices such as laptop or desktop computers, smartphones, PDAs, portable media players, tablet computers, televisions or other displays with one or more processors coupled thereto or embedded therein, or other appropriate computing devices that can be used for displaying a web application.

Electronic devices 102, 104 and 106 can be computing devices such as laptop or desktop computers, smartphones, PDAs, portable media players, tablet computers, televisions with one or more processors embedded therein and/or attached thereto, and/or other appropriate computing devices that can be used for associating contacts with corresponding system actions. In the example of FIG. 1, electronic device 102 is depicted as a smartphone, electronic device 104 is depicted as a desktop computer, and electronic device 106 is depicted as a PDA. A client is an application or a system that accesses a service made available by a server which is often (but not always) located on another computer system accessible by a network. Some client applications may be hosted on a website, whereby a browser is a client. Such implementations are within the scope of the subject disclosure, and any reference to client may incorporate a browser and reference to server may incorporate a website.

Application servers 120 may host various applications responsible for retrieving contact information for a contact profile and transmitting notifications, for example. Application servers 120 are in communication with the electronic devices 102, 104 and 106 through network 108. Each electronic device 102, 104 and 106 may be a client device or a host device. In some example aspects, server 110 can be a single computing device such as a computer server. In other embodiments, server 110 can represent more than one computing device working together to perform the actions of a server computer (e.g., cloud computing). The server 110 may host the web server communicationally coupled to the browser at the client device (e.g., electronic devices 102, 104 or 106) via network 108.

The network 108 can include, for example, any one or more of a personal area network (PAN), a local area network (LAN), a campus area network (CAN), a metropolitan area network (MAN), a wide area network (WAN), a broadband network (BBN), the Internet, and the like. Further, the network 108 can include, but is not limited to, any one or more of the following network topologies, including a bus network, a star network, a ring network, a mesh network, a star-bus network, tree or hierarchical network, and the like.

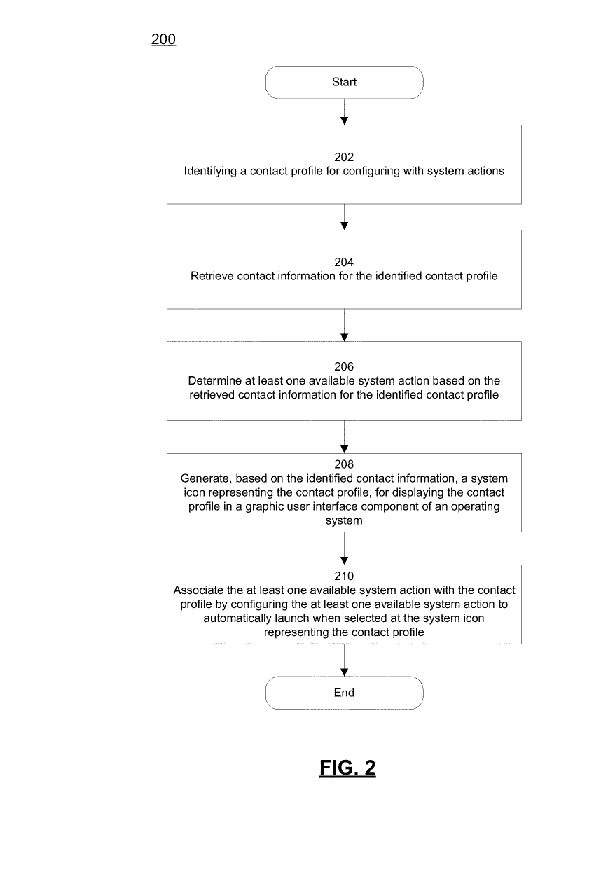

FIG. 2 illustrates a flow diagram of an example process 200 for associating contacts with corresponding system actions. At block 202, contact profiles are identified for configuring with system actions. Contact profiles may be identified from an address book that is stored on a local or remote device, or associated with the user profile. Contact profiles may also be identified based on user input, (e.g., a user selects one or more contacts to configure with various system actions.) Furthermore, contact profiles may be identified based on an online account, such as a social networking site, or a blogging service, for example. Still further, a contact profile may be identified based on a user's interactions with the contact corresponding to the contact profile. For example, an electronic message, text message or a phone call to or from a contact may serve as a basis for identifying a contact profile for the purpose of configuring the contact profile with system actions. A contact profile may also be identified based on user association with the contact profile at a social networking site. It may be determined that a user frequently comments on posts made by a contact at a social networking site or that the user and the contact are associated with each other, either directly or through mutual connections. The contact profile may also be identified based on such association. According to an aspect of the disclosed subject matter, a contact profile may correspond to a group or a list of contact profiles.

At block 202, contact information for the identified contact profile is retrieved. The contact information may be retrieved from an address book stored at a client device, a remote server, an online account or, alternatively, the contact information may be retrieved from the data attached to incoming or outgoing communications. Contact information may also be retrieved from a synched device or a synched application.

At block 206, at least one available system actions is determined. The at least one available system action is determined based on the retrieved contact information for the identified contact profile. For example, if retrieved contact information includes a telephone number, voice calling and SMS capabilities may be determined to be available system actions. Likewise, an email address or online account ID of an identified contact cause the system to determine that email may be sent to the contact. For example, when an ID for an internet-based call service (e.g., VOIP) is retrieved, the system may determine that an internet-based call may be placed to the identified contact. Available system actions include but are not limited to, composing an email message, composing an SMS or MMS message, placing a call, initiating a chat session, initiating a video conference, sharing or composing a document and posting a message at a social networking site.

At block 208, a system icon representing the contact profile is generated based on the identified contact information. The system icon is generated for displaying the contact profile in a graphic user interface component of an operating system. An avatar associated with an online profile or another photograph or image identifying a contact may be used as an icon cover. The icon is generated to look, feel, and act as any other application icon. It may be moved, re-sized, and pinned to a task bar.

At block 210, the at least one available system actions is associated with the contact profile by configuring the at least one available system actions to automatically launch when selected at the system icon representing the contact profile. That is, if an available system action, (e.g., email) is selected by a user at the system icon, a new email message may automatically be generated, addressed to the identified contact, for the user to compose and send to the identified contact. Contact information, such as an email address, may be automatically populated by the system. Alternatively, an email application may be called, and the user may compose the email message from the email application. Still further, when an available system action is an SMS, by selecting the SMS action, a text box may be provided into which the user may type the SMS message to be sent to the identified contact. The text box may be provided in-line, at the system icon, without the user having to leave the system icon or switch to a different application. The system icon includes all of the functionality that is available for a given contact, based on the retrieved contact information. Some system actions may be provided in-line, at the system icon, while other system actions may be configured to call up another application to complete a task.

Some identified contact profiles may be deemed priority contacts. The system may determine that a contact profile is a priority contact based on one of: interaction history, user preferences, user input or physical proximity. For example, a contact with whom a user frequently interacts may be deemed a priority contact. The level of frequency that is required may be set by a predetermined threshold. Alternatively, a contact who is in close physical proximity to the user may be deemed a priority contact. A client device may pick up signal that a contact is close by and treat that contact's profile as a priority contact for a period of time, while the contact's signal is within range. A user may also manually add contacts to a list of priority contacts or set rules or preferences for determining priority contacts. System icons for priority contacts may be provided for display in a task bar of the operating system, for easy access.

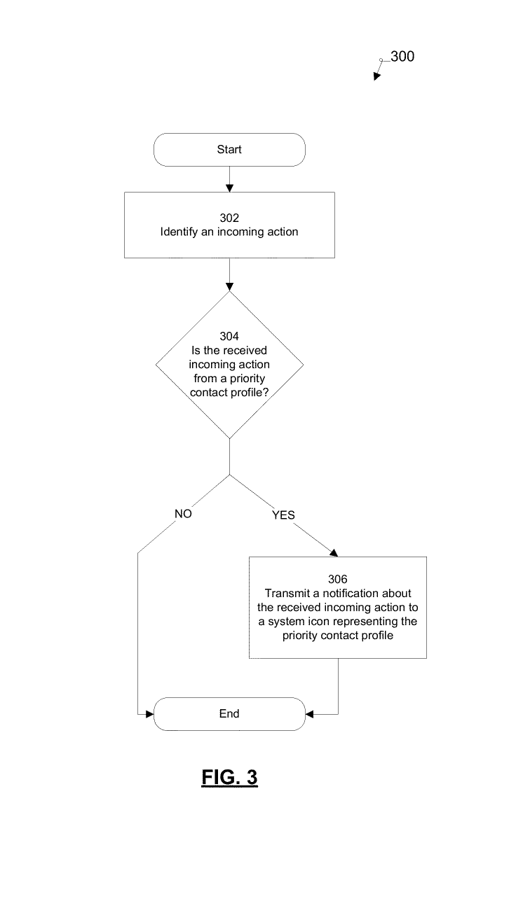

FIG. 3 illustrates a flow diagram of an example process 300 for transmitting notifications of incoming actions to system icons associated with priority contacts. At block 302, an incoming action is identified. An incoming action includes but is not limited to, an incoming email, SMS, document, instant message, video chat or the like. An incoming action may also be the detection of a contact profile who is physically within range.

At block 304, a determination is made as to whether the identified incoming action is from a priority contact profile. As described above, with reference to FIG. 2, a priority contact profile is identified based on at least one of interaction history, user preferences, user input or physical proximity. When it is determined that the identified incoming action is for a priority contact profile, process 300 proceeds to transmitting a notification about the identified incoming action to a system icon representing the priority contact profile at block 306. The identified incoming action is then accessible from the system icon representing the priority contact profile. That is, in a case where the incoming action is an email message, the email message is accessible from the system icon representing the priority contact profile.

According to an aspect of the disclosed technology, the system icon for priority contact profile is provided for display in a task bar of the operating system within which parts or all of the process 300 takes place. A notification badge may be displayed on the system icon representing the priority contact profile, to draw attention to the identified incoming action. A preview of the incoming action's content may also be provided.

The priority contact profile includes contact information for the priority contact profile. A further determination may be made regarding whether the incoming action corresponds to an available system action for the priority contact profile. Available system actions are those action that correspond to at least one part of the contact information for the identified contact profile. When the incoming action does not correspond to an available system action for the priority contact profile, process 300 may include generating, for the priority contact profile, a new system action and a new contact information part corresponding to the incoming action.

In a case the incoming action is not for a priority contact profile, the incoming action is processed within its corresponding application and the user may access it through the corresponding application. Alternatively, process 300 may also include determining whether the incoming action corresponds to an available contact profile. An available contact profile is a contact profile for which contact information may be retrieved from the system. Contact information for the available contact profile may be retrieved, and a system icon representing the available contact profile may be generated. The generated system icon representing the available contact profile may be provided for display in a task bar of the operating system, along with priority contact profiles. Thus, an incoming action may cause a contact profile to be treated as a priority contact profile and a system icon for the available contact profile to be pinned to a task bar, for the purpose of displaying the notification. A user may decide whether to keep or discard the system icon generated for a contact profile in response to an incoming action.

When an incoming action is received from an entity which is neither an available contact profile nor a priority contact profile, a new contact profile may be generated based on the incoming action. A system icon may be generated for the new contact profile and provided for display in a task bar of the operating system, for the purpose of displaying the notification. The user may then keep or discard the new system icon or profile associated therewith.

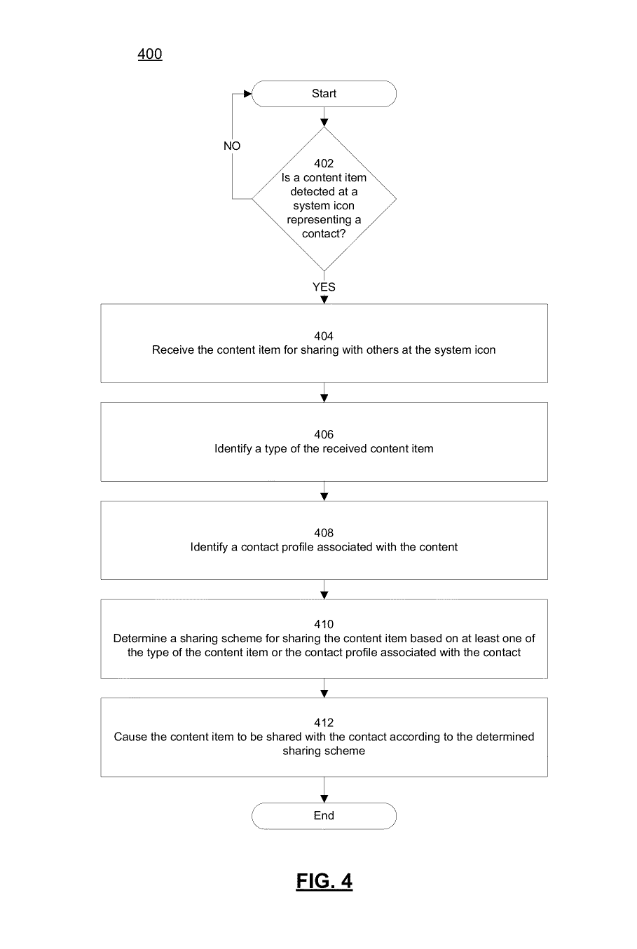

FIG. 4 illustrates a flow diagram of an example process 400 for sharing content. At block 402, the system determines whether a content item is detected at a system icon representing a client. A content item may be detected when, for example, a content item has been dragged and dropped onto the system icon, a paste operation that causes a content item to be transmitted to the system icon has been carried out with respect to the system icon, or the like. When a content item is dragged and dropped onto a system icon, the system may designate a zone around the system icon within which the content item may be dropped and within which the content item will be deemed to be directed to the particular system icon.

When the content item is detected at the system icon representing the contact, the system receives the content item at block 404. As used herein, receiving the content item may include accepting the transfer of the content item or a reference to the content item. Receiving the content item may also include storing the content item at a local drive. The content item may be stored in a temporary folder, until the process 400 is complete. The system may also identify the content item's location, in a case that the received content item is a reference to the content item, rather than a full file.

At block 406, the system identifies a type of the content item. That is the system may identify the file type, the size, the date of creation or modification, and other parameters. At block 408, the system identifies a contact profile associated with the contact represented by the system icon. That is, the system may look up the profile and determine whether the contact is a person, a business, or a group of people. For example, a contact may be custom defined by a user. Alternatively, a contact may be a social networking group or affiliation that is imported from the social network. The system may identify the available modes of communicating with the contact and the corresponding details. The system may further identify whether there are preferred modes of communication with the particular contact. The preferred mode of communication may be identified by the user or inferred by the system, based on a series of prior communications between the user and the contact. Certain contacts may be promoted by the system. That is, certain contacts that correspond to close friends or family members may have preferred modes of communication that are more immediate than other forms. For example, an SMS may be considered more immediate or higher priority than a social network post.

At block 410, the system determines a sharing scheme for sharing the content item with the contact. The sharing scheme is determined based on at least one of a type of the received content item or a contact profile associated with the contact represented by the system icon. That is, the system may consider one or more of the type of the content item and the contact profile. To that end, when the content item is identified as a photograph, the default sharing scheme may be to attach the photo to an instant message to the contact. When the content item is an album (more than one photo), the default sharing scheme may be to upload the album to a photo-sharing site with which the contact is affiliated. When a content item is a word document, the default sharing scheme may be to attach the word document to an email, if an email address is available. Alternatively, for a single photo shared to a group, rather than to one person, the default sharing scheme may be to post the photo to the group's social network feed. The sharing scheme may depend on multiple factors and various schemes may be implemented, based on the content item and the contact. Any default setting may be customized or personalized by a user.

At block 412, the system causes the content item to be shared with the contact according to the determined sharing scheme. Causing the received content item to be shared with the contact according to the determined sharing scheme, in response to receiving the content item at the system icon representing the contact may include launching an application corresponding to the determined sharing scheme and causing the received content item to be shared through the launched application. To that end, a destination location for the content item may be identified from the contact profile associated with the contact represented by the system icon and the received content item may be transmitted to the identified destination location. The destination location may be, for example, an email address, a URL, a social network account, etc.

Many of the above-described features and applications are implemented as software processes that are specified as a set of instructions recorded on a computer readable storage medium (also referred to as computer readable medium). When these instructions are executed by one or more processing unit(s) (e.g., one or more processors, cores of processors, or other processing units), they cause the processing unit(s) to perform the actions indicated in the instructions. Examples of computer readable media include, but are not limited to, CD-ROMs, flash drives, RAM chips, hard drives, EPROMs, etc. The computer readable media does not include carrier waves and electronic signals passing wirelessly or over wired connections.

In this specification, the term “software” is meant to include firmware residing in read-only memory or applications stored in magnetic storage, which can be read into memory for processing by a processor. Also, in some implementations, multiple software aspects of the subject disclosure can be implemented as sub-parts of a larger program while remaining distinct software aspects of the subject disclosure. In some implementations, multiple software aspects can also be implemented as separate programs. Finally, any combination of separate programs that together implement a software aspect described here is within the scope of the subject disclosure. In some implementations, the software programs, when installed to operate on one or more electronic systems, define one or more specific machine implementations that execute and perform the operations of the software programs.

A computer program (also known as a program, software, software application, script, or code) can be written in any form of programming language, including compiled or interpreted languages, declarative or procedural languages, and it can be deployed in any form, including as a stand alone program or as a module, component, subroutine, object, or other unit suitable for use in a computing environment. A computer program may, but need not, correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

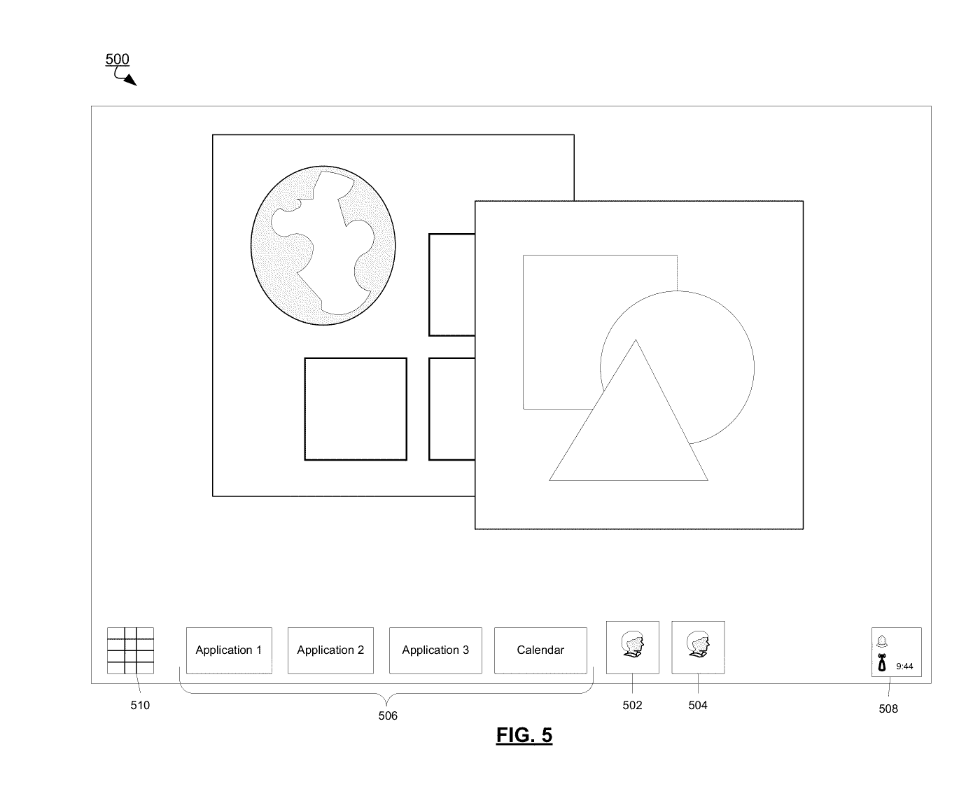

FIG. 5 illustrates an example graphical implementation of a system for sharing content according to an aspect of the disclosed technology. The graphic implementation illustrates a system icon 502 and a system icon 504. The system icons 502 and 504 are applications that are personalized to a contact represented by the system icon. The system icon 502 may include a menu of available functions that may be carried out with respect to the contact represented by the system icon 504. For example, modes of contacting the contact may be accessible through the system icon 502. Most recent communications with the contact may also be previewed through system icon 502. When a message from the contact is received, the system icon 502 may display a notification about the new message. The system icon may also have a measure for informing the user whether the contact represented by the system icon is on line and available for an online chat.

Other applications, collectively represented as 506 may also be represented in the system tray or anywhere else on the desktop screen of an operating system. The operating system may be accessible through element 508. For example, other applications and programs may be accessed through element 508. Operating system statuses may be represented in element 510. For example, internet connectivity, time, battery level may be shown through element 510.

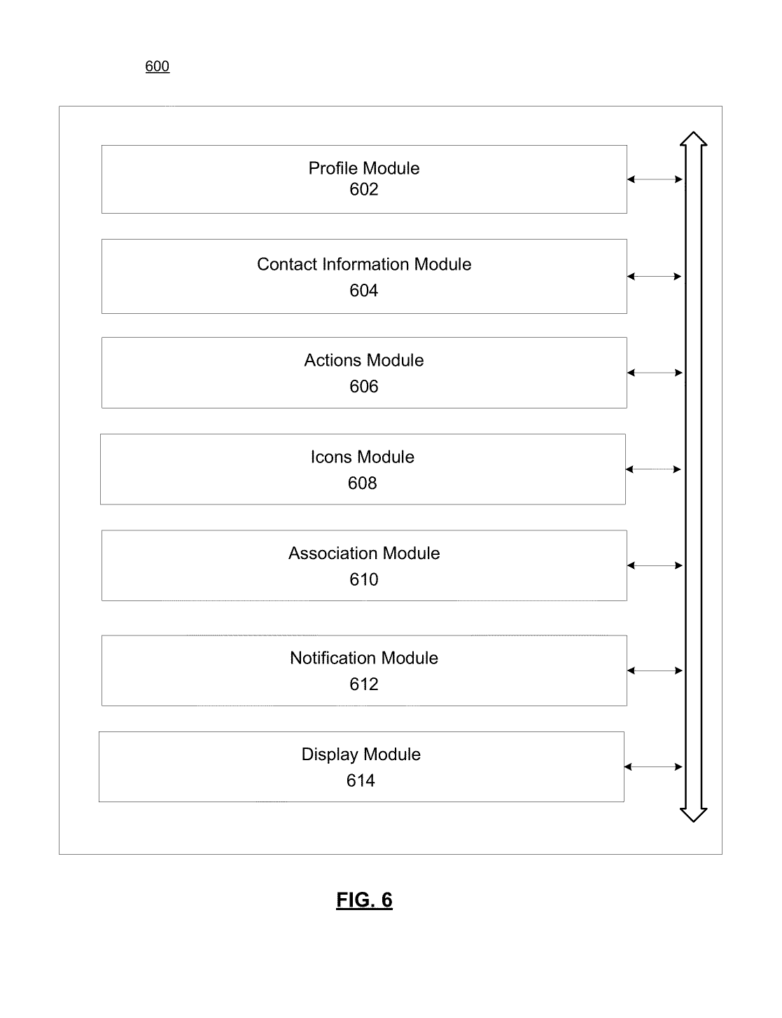

FIG. 6 illustrates an example of system 600 for associating contacts with corresponding system actions, in accordance with various aspects of the subject technology. System 600 comprises a profile module 602, a contact information module 604, an actions module 606, an icons module 608, an association module 610, a notification module 612 and a display module 614.

The profile module 602 is configured to identify a contact profile for configuring with system actions, based on one or more of an address book, user input, online accounts, or an interaction with a contact corresponding to the contact profile. The contact information module 604 is configured to retrieve contact information for the identified contact profile. The actions module 606 is configured to determine at least one available system action based on the retrieved contact information for the identified contact profile, wherein each available system action corresponds to at least one part of the retrieved contact information for the identified contact profile. The icons module 608 is configured to generate, based on the retrieved contact information, a system icon representing the contact profile for displaying the contact profile in a graphic user interface component of an operating system.

The association module 610 is configured to associate the at least one available system action with the contact profile by configuring the at least one available system action to automatically launch when selected at the system icon representing the contact profile. The notification module 612 is configured to transmit, in a case where the identified contact profile is a priority contact, a notification to the system icon representing the contact profile about incoming actions corresponding to the available system actions. The display module 614 is configured to determine whether the identified contact profile is a priority contact, based on at least one of interaction history, user preferences, user input or physical proximity and to provide, in a case where the identified contact profile is a priority contact, the system icon representing the contact profile for display in a task bar of the operating system.

These modules may be in communication with one another. In some aspects, the modules may be implemented in software (e.g., subroutines and code). In some aspects, some or all of the modules may be implemented in hardware (e.g., an Application Specific Integrated Circuit (ASIC), a Field Programmable Gate Array (FPGA), a Programmable Logic Device (PLD), a controller, a state machine, gated logic, discrete hardware components, or any other suitable devices) and/or a combination of both. Additional features and functions of these modules according to various aspects of the subject technology are further described in the present disclosure.

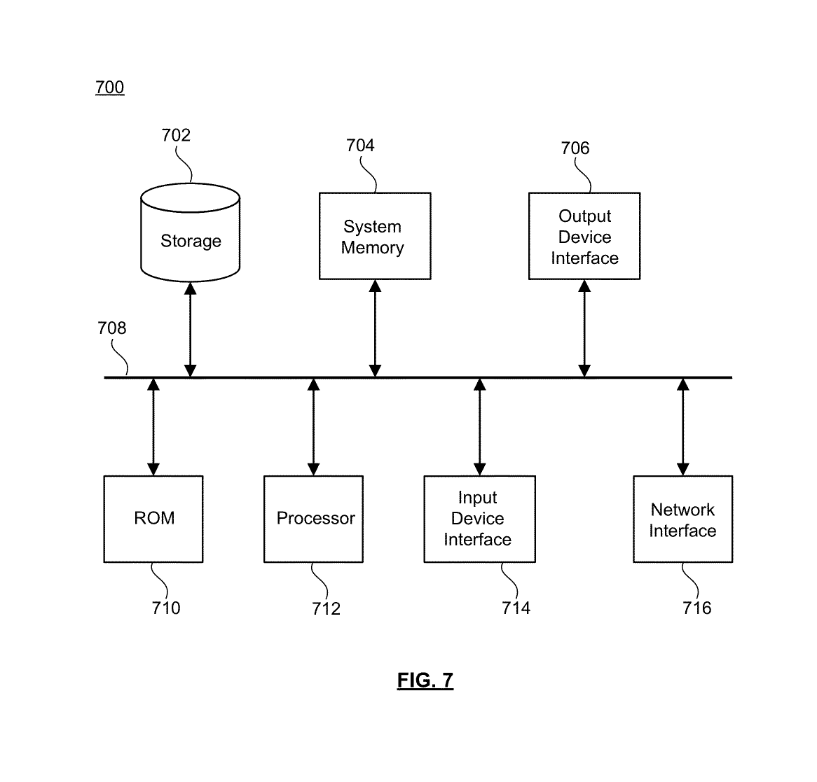

FIG. 7 conceptually illustrates an electronic system with which some aspects of the subject technology are implemented. Electronic system 700 can be a server, computer, phone, PDA, laptop, tablet computer, television with one or more processors embedded therein or coupled thereto, or any other sort of electronic device. Such an electronic system includes various types of computer readable media and interfaces for various other types of computer readable media. Electronic system 700 includes a bus 708, processing unit(s) 712, a system memory 704, a read-only memory (ROM) 710, a permanent storage device 702, an input device interface 714, an output device interface 706, and a network interface 716.

Bus 708 collectively represents all system, peripheral, and chipset buses that communicatively connect the numerous internal devices of electronic system 700. For instance, bus 708 communicatively connects processing unit(s) 712 with ROM 710, system memory 704, and permanent storage device 702.

From these various memory units, processing unit(s) 712 retrieves instructions to execute and data to process in order to execute the processes of the subject disclosure. The processing unit(s) can be a single processor or a multi-core processor in different implementations.

ROM 710 stores static data and instructions that are needed by processing unit(s) 712 and other modules of the electronic system. Permanent storage device 702, on the other hand, is a read-and-write memory device. This device is a non-volatile memory unit that stores instructions and data even when electronic system 700 is off. Some implementations of the subject disclosure use a mass-storage device (such as a magnetic or optical disk and its corresponding disk drive) as permanent storage device 702.

Other implementations use a removable storage device (such as a floppy disk, flash drive, and its corresponding disk drive) as permanent storage device 702. Like permanent storage device 702, system memory 704 is a read-and-write memory device. However, unlike storage device 702, system memory 704 is a volatile read-and-write memory, such a random access memory. System memory 704 stores some of the instructions and data that the processor needs at runtime. In some implementations, the processes of the subject disclosure are stored in system memory 704, permanent storage device 702, and/or ROM 710. From these various memory units, processing unit(s) 712 retrieves instructions to execute and data to process in order to execute the processes of some implementations.

Bus 708 also connects to input and output device interfaces 714 and 706. Input device interface 714 enables the user to communicate information and select commands to the electronic system. Input devices used with input device interface 714 include, for example, alphanumeric keyboards and pointing devices (also called “cursor control devices”). Output device interfaces 706 enables, for example, the display of images generated by the electronic system 700. Output devices used with output device interface 706 include, for example, printers and display devices, such as cathode ray tubes (CRT) or liquid crystal displays (LCD). Some implementations include devices such as a touch screen that functions as both input and output devices.

Finally, as shown in FIG. 7, bus 708 also couples electronic system 700 to a network (not shown) through a network interface 716. In this manner, the computer can be a part of a network of computers (such as a local area network (“LAN”), a wide area network (“WAN”), or an Intranet, or a network of networks, such as the Internet. Any or all components of electronic system 700 can be used in conjunction with the subject disclosure.

These functions described above can be implemented in digital electronic circuitry, in computer software, firmware or hardware. The techniques can be implemented using one or more computer program products. Programmable processors and computers can be included in or packaged as mobile devices. The processes and logic flows can be performed by one or more programmable processors and by one or more programmable logic circuitry. General and special purpose computing devices and storage devices can be interconnected through communication networks.

Some implementations include electronic components, such as microprocessors, storage and memory that store computer program instructions in a machine-readable or computer-readable medium (alternatively referred to as computer-readable storage media, machine-readable media, or machine-readable storage media). Some examples of such computer-readable media include RAM, ROM, read-only compact discs (CD-ROM), recordable compact discs (CD-R), rewritable compact discs (CD-RW), read-only digital versatile discs (e.g., DVD-ROM, dual-layer DVD-ROM), a variety of recordable/rewritable DVDs (e.g., DVD-RAM, DVD-RW, DVD+RW, etc.), flash memory (e.g., SD cards, mini-SD cards, micro-SD cards, etc.), magnetic and/or solid state hard drives, read-only and recordable Blu-Ray® discs, ultra density optical discs, any other optical or magnetic media, and floppy disks. The computer-readable media can store a computer program that is executable by at least one processing unit and includes sets of instructions for performing various operations. Examples of computer programs or computer code include machine code, such as is produced by a compiler, and files including higher-level code that are executed by a computer, an electronic component, or a microprocessor using an interpreter.

While the above discussion primarily refers to microprocessor or multi-core processors that execute software, some implementations are performed by one or more integrated circuits, such as application specific integrated circuits (ASICs) or field programmable gate arrays (FPGAs). In some implementations, such integrated circuits execute instructions that are stored on the circuit itself.

As used in this specification and any claims of this application, the terms “computer”, “server”, “processor”, and “memory” all refer to electronic or other technological devices. These terms exclude people or groups of people. For the purposes of the specification, the terms display or displaying means displaying on an electronic device. As used in this specification and any claims of this application, the terms “computer readable medium” and “computer readable media” are entirely restricted to tangible, physical objects that store information in a form that is readable by a computer. These terms exclude any wireless signals, wired download signals, and any other ephemeral signals.

To provide for interaction with a user, implementations of the subject matter described in this specification can be implemented on a device having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

Embodiments of the subject matter described in this specification can be implemented in a computing system that includes a back end component, e.g., as a data server, or that includes a middleware component, e.g., an application server, or that includes a front end component, e.g., a client computer having a graphical user interface or a Web browser through which a user can interact with an implementation of the subject matter described in this specification, or any combination of one or more such back end, middleware, or front end components. The components of the system can be interconnected by any form or medium of digital data communication, e.g., a communication network. Examples of communication networks include a local area network (“LAN”) and a wide area network (“WAN”), an inter-network (e.g., the Internet), and peer-to-peer networks (e.g., ad hoc peer-to-peer networks).

The computing system can include clients and servers. A client and server are generally remote from each other and typically interact through a communication network. The relationship of client and server arises by virtue of computer programs running on the respective computers and having a client-server relationship to each other. In some embodiments, a server transmits data (e.g., an HTML page) to a client device (e.g., for purposes of displaying data to and receiving user input from a user interacting with the client device). Data generated at the client device (e.g., a result of the user interaction) can be received from the client device at the server.

It is understood that any specific order or hierarchy of steps in the processes disclosed is an illustration of exemplary approaches. Based upon design preferences, it is understood that the specific order or hierarchy of steps in the processes may be rearranged, or that some illustrated steps may not be performed. Some of the steps may be performed simultaneously. For example, in certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but are to be accorded the full scope consistent with the language claims, wherein reference to an element in the singular is not intended to mean “one and only one” unless specifically so stated, but rather “one or more.” Unless specifically stated otherwise, the term “some” refers to one or more. Pronouns in the masculine (e.g., his) include the feminine and neuter gender (e.g., her and its) and vice versa. Headings and subheadings, if any, are used for convenience only and do not limit the subject disclosure.

A phrase such as an “aspect” does not imply that such aspect is essential to the subject technology or that such aspect applies to all configurations of the subject technology. A disclosure relating to an aspect may apply to all configurations, or one or more configurations. A phrase such as an aspect may refer to one or more aspects and vice versa. A phrase such as a “configuration” does not imply that such configuration is essential to the subject technology or that such configuration applies to all configurations of the subject technology. A disclosure relating to a configuration may apply to all configurations, or one or more configurations. A phrase such as a configuration may refer to one or more configurations and vice versa.

The word “exemplary” is used herein to mean “serving as an example or illustration.” Any aspect or design described herein as “exemplary” is not necessarily to be construed as preferred or advantageous over other aspects or designs.

All structural and functional equivalents to the elements of the various aspects described throughout this disclosure that are known or later come to be known to those of ordinary skill in the art are expressly incorporated herein by reference and are intended to be encompassed by the claims.

What is claimed is:

1. A computer-implemented method for associating contacts with corresponding system actions, the method comprising:
identifying a contact profile for configuring with system actions, based on one or more of an address book, user input, online accounts, or an interaction with a contact corresponding to the contact profile;
retrieving contact information for the identified contact profile;
determining at least one available system action based on the retrieved contact information for the identified contact profile, wherein each available system action corresponds to at least one part of the retrieved contact information for the identified contact profile;
generating, based on the retrieved contact information, a system icon representing the contact profile for displaying the contact profile in a graphic user interface component of an operating system; and
associating the at least one available system action with the contact profile by configuring the at least one available system action to automatically launch when selected at the system icon representing the contact profile.

2. The computer-implemented method of claim 1, further comprising:
determining whether the identified contact profile is a priority contact, based on at least one of interaction history, user preferences, user input or physical proximity; and
providing, in a case where the identified contact profile is a priority contact, the system icon representing the contact profile for display in a task bar of the operating system.

3. The computer-implemented method of claim 2, method further comprising:
transmitting, in a case where the identified contact profile is a priority contact, a notification to the system icon representing the contact profile about incoming actions corresponding to the at least one available system action.

4. The computer-implemented method of claim 1, wherein associating the at least one available system action with the contact profile by configuring the at least one available system action to automatically launch when selected at the system icon representing the contact profile comprises providing the system icon with in-line system actions, wherein the in-line system actions are configured to receive input from a user at the system icon and transmit the received input to an application corresponding to the system action.

5. The computer-implemented method of claim 1, wherein associating the at least one available system action with the contact profile by configuring the at least one available system action to automatically launch when selected at the system icon representing the contact profile comprises automatically populating fields of data from the contact profile in a graphic user interface corresponding to the at least one available system action, when launching the at least one available system action.

6. The computer-implemented method of claim 1, wherein the contact profile comprises one or more profiles for a group of contacts.

7. The computer-implemented method of claim 1, wherein identifying the contact profile for configuring with system actions comprises identifying the contact profile based on user association with the contact profile at a social networking site.

8. The computer-implemented method of claim 1, wherein available system actions comprise one or more of composing an email message, composing an SMS message, composing an MMS message, placing a call, initiating a chat session, initiating a video conference, sharing a document, posting a message at a social networking site or composing a document.

9. A machine-readable medium comprising instructions stored therein, which when executed by the processors, cause the processors to perform operations comprising:
identifying an incoming action;
determining whether the identified incoming action is from a priority contact profile, wherein the priority contact profile is identified based on at least one of interaction history, user preferences, user input or physical proximity; and
in a case where the identified incoming action is for the priority contact profile, transmitting a notification about the identified incoming action to a system icon representing the priority contact profile, wherein the identified incoming action is accessible from the system icon representing the priority contact profile.

10. The machine-readable medium of claim 9, wherein the priority contact profile comprises contact information for the priority contact profile and wherein the operations further comprise:
determining whether the incoming action corresponds to at least one available system action for the priority contact profile, wherein the at least one available system action corresponds to at least one part of the contact information for the identified contact profile.

11. The machine-readable medium of claim 10, wherein, in a case the incoming action does not correspond to at least one available system action for the priority contact profile, the operations further comprising:
generating a new system action corresponding to the incoming action and a new contact information part corresponding to the incoming action, for the priority contact profile.

12. The machine-readable medium of claim 9, wherein, in a case the incoming action is not for the priority contact profile, the operations further comprising:
determining whether the incoming action corresponds to at least one available contact profile.

13. The machine-readable medium of claim 12, wherein in a case where the incoming action corresponds to the at least one available contact profile, the operations further comprising:
retrieving contact information for the at least one available contact profile;
generating a system icon representing the at least one available contact profile; and
providing the generated system icon representing the at least one available contact profile for display in a task bar of the operating system.

14. The machine-readable medium of claim 12, wherein, in a case the incoming action is not from the at least one available contact profile, the operations further comprising:
generating a new contact profile based on the in the incoming action.

15. The machine-readable medium of claim 14, the operations further comprising:
generating a system icon representing the new contact profile; and
providing the generated system icon representing the new contact profile for display in a task bar of the operating system.

16. A computer-implemented method for sharing content, the method comprising:
receiving, at a system icon representing a contact, a content item for sharing with the contact;
determining, based on at least one of a type of the received content item or a contact profile associated with the contact represented by the system icon, a sharing scheme for sharing the received content item with the contact; and
causing the received content item to be shared with the contact according to the determined sharing scheme, in response to receiving the content item at the system icon representing the contact.

17. The computer-implemented method of claim 16, wherein determining, based at least on one of the type of the received content item or the contact profile associated with the contact represented by the system icon, a sharing scheme for sharing the received content item with the contact, further comprises:
determining the file type for the received content item; and
selecting a sharing scheme that corresponds to the determined file type.

18. The computer-implemented method of claim 16, wherein determining, based at least on one of the type of the received content item or the contact profile associated with the contact represented by the system icon, a sharing scheme for sharing the received content item with the contact, further comprises:
identifying the contact profile associated with the contact; and
selecting a sharing scheme that corresponds to the identified contact profile associated with the contact.

19. The computer-implemented method of claim 16, wherein causing the received content item to be shared with the contact according to the determined sharing scheme, in response to receiving the content item at the system icon representing the contact comprises:
launching an application corresponding to the determined sharing scheme; and
causing the received content item to be shared through the launched application.

20. The computer-implemented method of claim 19, wherein causing the received content item to be shared through the launched application comprises:
identifying a destination location for the content item from the contact profile associated with the contact represented by the system icon; and
transmitting the received content item to the identified destination location.
